(19) United States
(12) Patent Application Publication
(10) Pub. No.: US 2012/0176218 A1
(43) Pub. Date: Jul. 12, 2012

(54) UNMANNED SECURITY SYSTEM USING NETWORK, METHOD FOR PROVIDING UNMANNED SECURITY SERVICE, AND METHOD FOR SETTING UNMANNED SECURITY SYSTEM

(76) Inventor: Hyun Jin AHN, Seoul (KR)

(21) Appl. No.: 13/496,292

(22) PCT Filed: Aug. 2, 2010
(86) PCT No.: PCT/KR2010/005068

§ 371 Date: Mar. 15, 2012

(30) Foreign Application Priority Data
Mar. 2, 2010 (KR) 10-2010-0018691

(51) Int. Cl. G06F 7/04; H04N 7/18

(52) U.S. Cl. 340/5.54; 348/159; 348/E07.085

(57) ABSTRACT

The present invention relates to an unmanned security system using a network for sensing a trespasser and rapidly coping with the trespassing without a delay before the trespasser escapes, a method for providing an unmanned security service, and a method for setting an unmanned security system.

The unmanned security system using a network includes a plurality of sensors configured to sense an abnormal state of a specific location and output a sensing signal; one or more cameras installed in the specific location and configured to generate image data and sound data and output the image data and sound data; a Dynamic Domain Name Service (DDNS) server configured to manage Internet addresses for Internet access to provide the image data and sound data of the cameras; an SMS transmission DB server configured to transmit a message regarding the abnormal state of the specific location to a plurality of users related to the specific location using at least two of voice guide, text message, e-mail and facsimile when the abnormal state of the specific location is sensed through the sensors and/or the cameras; a web server configured to create a web page with security related information; a management control server configured to manage states of the sensors and the cameras, receive the image data and sound data from the cameras, store the received image data and sound data, and administrate the DDNS server, the SMS transmission DB server and the web server in an integrated manner; and a terminal configured to receive the web page through the network. According to this configuration, an occurrence of crime is notified by simultaneously transmitting a message to a plurality of users in real time, and thus a person who is in a best environment can rapidly cope with the occurrence of crime by immediately grasping the situation of the scene without missing important information.

### CROSS-REFERENCE TO RELATED APPLICATION

This application claims priority to PCT Application No. PCT/KR2010/005068, filed Aug. 2, 2010, which claims priority and the benefit of Korean Patent Application No. 10-2010-0018691 filed in the Korean Intellectual Property Office on Mar. 2, 2010, the entire contents of both of which are incorporated herein by reference.

### BACKGROUND OF THE INVENTION

(a) Field of the Invention

The present invention relates to an unmanned security system using a network, a method for providing an unmanned security service, and a method for setting an unmanned security system. More specifically, the present invention relates to an unmanned security system using a network for sensing a trespasser and rapidly coping with the trespassing without a delay before the trespasser escapes, a method for providing an unmanned security service, and a method for setting an unmanned security system.

(b) Description of the Related Art

With recent development of electronics and communication industries, security, crime prevention and safety networks have been constructed and visitors and trespassers have been photographed in places such as banks and national industrial organizations to reinforce security systems.

In view of this, an unmanned security system is installed in an area where security and crime prevention are required.

The unmanned security system is installed in a home, an office or a store to sense a trespass in the absence of client and warn or call the client.

Specifically, the unmanned security system senses or monitors fire, robbery, gas leakage, etc. using a sensor or a surveillance camera, generates alarm sound based on the sensed or monitored result or notifies a security service company, a security office, or janitor's office of the accident through a dedicated line, or automatically calls the fire station or police station.

The unmanned security system is constructed in such a manner that surveillance cameras or a variety of sensors are installed in places or locations which require security and crime prevention in a home, an apartment complex, a company building, etc. to acquire image signals using the surveillance cameras or receive signals sensed by the sensors.

The unmanned security system transmits the acquired image signals and sensed signals to warn the corresponding client and remotely transmits/receives voice or data as necessary so as to rapidly inform the corresponding unmanned security company of a security trouble.

However, the conventional unmanned security system is constructed in such a manner that only the security service company and control center can monitor situations and operated only in a standard pattern, and thus operation flexibility of the system is deteriorated.

Further, the client cannot monitor and cope with an emergency until a remote control center takes a measure against the emergency, and cannot personally check the situation of the scene.

To solve this, an unmanned security system is under development which is able to 24-hour monitor or remotely control the state of a security zone requested by a client from any place under Internet environment.

Specifically, the unmanned security system monitors the security zone using a variety of sensors and provides information sensed by the sensors to a main server through the Internet such that a control center connected to the main server confirms the warned situation and, simultaneously, the client accesses the main server through a network to control and monitor the security zone.

This unmanned security system can allow the client to directly monitor the security zone through double surveillance according to the client and service provider and when the security zone has a crime prevention or security trouble, provide rapid security service to the security zone.

However, in the event of accident, the accident is sequentially notified to many people including the security company, client, and police, to result in time delay.

The time delay may provide a sufficient time for a trespasser to escape before the security service or police is arrived, and thus the trespasser is more likely to accomplish the trespassing purpose and escape.

Further, users cannot easily use the above-mentioned unmanned security system through mobile terminals currently increasingly used due to a processing speed problem. In addition, since the unmanned security system is managed only by appointed people, a user is not helped by neighbors or neighboring police even in a situation in which the neighbors or police can help the user so that the user can be damaged.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an unmanned security system using a network, a method for providing an unmanned security service, and a method for setting an unmanned security system for sensing a trespasser and rapidly coping with the trespassing without a delay before the trespasser escapes in a flexible and complementary manner using neighboring infrastructures such as neighbors and neighboring police immediately, changing alert setup as necessary, and easily using an unmanned security service through an alert setting window on a mobile terminal.

To accomplish the object of the present invention, there is provided an unmanned security system using a network, which includes a plurality of sensors configured to sense an abnormal state of a specific location and output a sensing signal; one or more cameras installed in the specific location and configured to generate image data and sound data and output the image data and sound data; a Dynamic Domain Name Service (DDNS) server configured to manage Internet addresses for Internet access to provide the image data and sound data of the cameras; an SMS transmission DB server configured to transmit a message regarding the abnormal state of the specific location to a plurality of users related to the specific location using at least two of voice guide, text message, e-mail and facsimile when the abnormal state of the specific location is sensed through the sensors and/or the cameras; a web server configured to create a web page with security related information; a management control server configured to manage states of the sensors and the cameras, receive the image data and sound data from the cameras, store the received image data and sound data, and administrate the DDNS server, the SMS transmission DB server and the web server in an integrated manner; and a terminal configured to receive the web page through the network.

As described above, according to the present invention, an occurrence of crime is notified by simultaneously transmitting a message to a plurality of users in real time, and thus a person who is in a best environment can rapidly cope with the occurrence of crime by immediately grasping the situation of the scene without missing important information.

### BRIEF DESCRIPTION OF THE DRAWINGS

FIG. 1 illustrates a configuration of an unmanned security system using a network according to an exemplary embodiment of the present invention;

FIG. 2 shows an interface screen of a mobile terminal supported by the unmanned security system using a network according to an exemplary embodiment of the present invention;

FIG. 3 is a flowchart illustrating a method for providing an unmanned security service using a network according to an exemplary embodiment of the present invention;

FIG. 4 is a flowchart illustrating a method for setting an unmanned security system using a network according to an exemplary embodiment of the present invention;

FIGS. 5, 6 and 7 show exemplary display screens for explaining the method for setting an unmanned security system using a network according to an exemplary embodiment of the present invention; and

FIG. 8 shows an alert setting list window in the unmanned security system using a network according to an exemplary embodiment of the present invention.

### DETAILED DESCRIPTION OF THE EMBODIMENTS

Reference will now be made in detail to the preferred embodiments of the present invention with reference to the accompanying drawings. The same reference numbers will be used throughout this specification to refer to the same or like parts. Further, detailed description of known structures or functions is omitted, focusing on important features of the structures or functions, so as not to obscure the concept of the invention.

<Description of System>

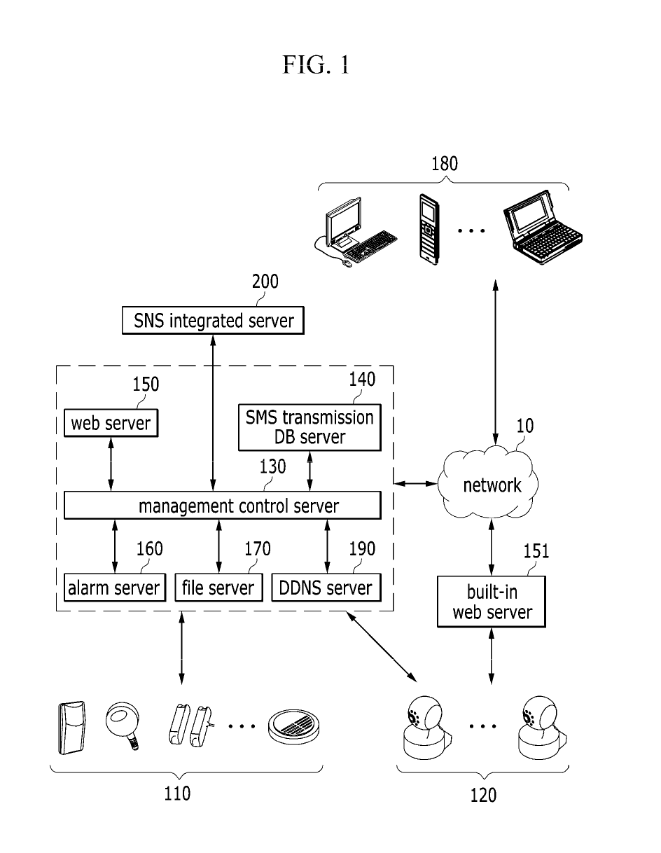

FIG. 1 illustrates a configuration of an unmanned security system 100 using a network 10 according to an exemplary embodiment of the present invention;

Referring to FIG. 1, the unmanned security system 100 using the network 10 according to an exemplary embodiment of the present invention includes a sensor 110, one or more cameras 120, a Dynamic Domain Name Service (DDNS) server 190, a management control server 130, a SMS transmission DB server 140, a web server 150, a built-in web server 151, an alarm server 160, a file server 170, and a terminal 180.

The sensor 110 includes a variety of sensors such as an infrared sensor, an impact sensor, a door sensor, a glass sensor, a smoke sensor, an entrance sensor, a fire sensor, etc. The sensor 110 senses an abnormal status of a specific location which requires crime prevention, surveillance or security, for example, an entrance, a window, a parking lot, or the inside of a building and outputs a sensing signal.

The sensor 110 is connected to the camera 120 in a cross manner.

The one or more cameras 120 are installed in the specific location and include a speaker and a microphone to generate and output image data and sound data.

This supports bidirectional audio service to enable real-time remote conversation and listening to sound from an accident occurrence scene.

When an image is input to the camera 120, the image is processed into a file, the file is compressed into video data, and the video data is transmitted through the network 10.

The camera 120 is a wireless IP camera and has advantages that WI-FI can be established in any place which can be covered by a wireless LAN without LAN or cable wiring and states of floors wirelessly connected to the first floor can be sensed in real time from the first floor.

This eliminates the necessity of drilling holes in ceilings or wiring to reduce a construction time and achieve rapid installation compared to CCTV, thereby cutting down construction cost and personal expenses by 90%, and enables even an unskilled person to easily perform an extension of installation only according to a manual.

In the event of trespassing, image data generated by the camera 120 may be stored in a memory of the camera 120.

The camera 120 is preferably installed in a direction toward a window to maintain stability of radio waves, and has a function of encoding radio signals to perfectly maintain security. In addition, the camera 120 includes at least eight LEDs to extend night visibility to thereby obtain high-quality images even at night.

The camera 120 is attached to the ceiling such that it can rotate 360 degrees horizontally and 80 degrees vertically to eliminate a blind zone. The rotation angle of the camera 120 is remotely controlled through a home page which administrates the unmanned security system to monitor the corresponding security zone in real time.

A user can check an image transmitted from the camera 120 in real time using the terminal 180 and, simultaneously, hear a voice. In addition, the user can generate a voice signal, and thus in the event of trespassing, the user can cope with the trespassing in real time in such a manner that the user performs appropriate alert broadcasting.

In this case, the user can access the web server 150 through the terminal 180 to check images. Image upload may be set in the camera 120.

The camera 120 has a robbery tracking function, and thus, when the camera 120 is stolen, the management control server 130 can perform back tracking so as to inform the user of access information through SMS.

Accordingly, even when the camera 120 is stolen, the camera 120 cannot be used by a person other than the user, thereby rooting up robbery problem.

The DDNS server 190 manages Internet addresses for Internet access to provide the image data and sound data generated by the camera 120.

The user can access the camera 120 through the DDNS server 190 to change or modify configuration regardless of the management control server 130.

To achieve this, the built-in web server 151 is provided which stores ID and port of the camera 120.

For example, when the user wants to see image information generated by the camera 120, the user can directly access the built-in web server 151 to check the image information by inputting a predetermined address into an address window of the web page.

In other words, the image information is directly provided by the camera 120 without via the management control server 130 rather than provided by the management control server 130, which corresponds to peer-to-peer scheme.

The management control server 130 manages states of the sensor 110 and the camera 120, receives the image data and sound data from the camera 120, stores them, and administrates the DDNS server 190, the SMS transmission DB server 140 and the web server 150 in an integrative manner.

The SMS transmission DB server 140 transmits a message regarding an abnormal status of the specific location to a plurality of users related to the specific location using at least two of voice guide, text message, e-mail, and facsimile when the abnormal status of the specific location is sensed by at least one of the sensor 110 and the camera 120.

Accordingly, it is possible to notify a plurality of users of an occurrence of crime through simultaneous multi-posting in real time rather than priority posting, and thus a person who is in a best environment can rapidly cope with the occurrence of crime to grasp the situation immediately without missing important information.

That is, the occurrence of crime is simultaneously notified to many people including the security company, client, police, etc. rather than being sequentially notified to the many people, and thus a delay is not generated.

Therefore, many people can rapidly seize the trespasser before the trespasser escapes, improving safety and security.

For example, when the camera 120 senses a trespasser and transmits data corresponding to the sensed result to the management control server 130, the data is compared with condition values stored in the management control server 130, and the SMS transmission DB server 140 notifies a plurality of users of the trespassing when the data corresponds to the condition values.

Then, the plurality of users can log in using the terminal 180 to check the image data and sound data generated by the camera 120 and cope with the trespassing depending on checked information.

The SMS transmission DB server 140 simultaneously notifies the users of the trespassing using voice guide, text message and facsimile and transmits image data using e-mail.

The management control server 130 manages the details of the notification and transmits them to the SMS integrated server 200. The SMS integrated server 200 charges communication expenses by mobile network operators classified by numbers.

Moreover, it is possible to ring a phone bell at a specific position to alarm a trespasser such that the trespasser runs away.

The SMS transmission DB server 140 selectively transmits a message based on alert importance according to a scheme predetermined by the user. To implement this, the SMS transmission DB server 140 stores condition values such that the user can set various scenarios depending on desired situations and environments.

Specifically, the SMS transmission DB server 140 can transmit a message to the user through a phone, facsimile or SMS set by the user when an abnormal status sensing signal is generated in a period of time set by the user.

The user sets a phone, facsimile or SMS through the terminal 180 using a web page which administrates the unmanned security system 100, or WYSIWYG or shortcut button which facilitates access to the web page. When an abnormal status is sensed, the user is notified of the abnormal status through a mobile phone, facsimile or e-mail set by the user, which will be described in detail later.

The web server 150 creates a web page with security related information. When the sensor 110 senses an abnormal status, over 100 images are stored in a history gallery and used as evidence in case of emergency.

The alarm server 160 transmits/receives signals to/from the camera 120 at an interval of 30 seconds to check the operation of the camera 120 approximately 2880 times per day and when the camera 120 is not operated normally due to failure such as power failure or short-circuit, network failure, and switch failure, notifies the user of the abnormal operation of the camera through SMS. When the failure is recovered, the alarm server 160 automatically notifies the user of the recovery through SMS.

Accordingly, it is possible to solve a difficulty in gathering evidence due to an abnormal operation of the camera 120.

The file server 170 separately stores the image data. In the event of trespassing, image data with respect to the trespassing is stored in the camera 120 and, simultaneously, transmitted to the file server 170.

This is for the purposing of preparing for a case in which the image data cannot be checked or obtained due to an unexpected cause.

The terminal 180 is a portable terminal such as a normal PC, WI-FI i-phone, PDA or the like. The terminal 180 can receive the web page through the network 10, and easily access the web page through a setting window using a shortcut, shortcut button or WYSIWYG even when the user is not connected through the web page.

The network 10 includes a general telephone network, ISDN, LAN, etc. and is used as a communication medium capable of remotely sensing a status of the location or spot where the camera 120 and the sensor 110 are installed. The user can manage and monitor operating states of the camera 120 and the sensor 110 and check guard record, notification record, entrance/exit record, etc. by inputting a user ID and password to the home page.

As described above, the user can perform surveillance through the Internet regardless of time and place in such a manner that the user performs continuous monitoring and remote control using the network 10. Further, in the event of accident, the user can directly control the accident in such a manner that the user calls in the police or acquaintance closest to the user based on the situation. In this manner, the unmanned security system is efficiently used to capture a criminal.

The user who is notified of a trespassing can grasp the situation of the scene, such as the number of trespassers, descriptions of the trespassers, characteristics, etc. in real time and report to the police, and thus there is no erroneous report and the police can rapidly go to the scene.

In the present invention, an alert state is set based on a specific pattern such as the going-to-work hour, the work-leaving hour, sleeping hours, the rising hour, work, duty, etc. such that the alert state and alert cancellation are automatically repeated at a corresponding time without a wireless switch. In addition, the unmanned security system 100 is automatically operated on holidays and legal holidays. When changes are generated, the user can log in to easily change the alert state on an intuitive interface in the same manner as the user checks e-mail.

For users who do not have much experience in using the terminal 180, an additional analog switch, icon, shortcut button or the like is preferably provided to activate the alert state or cancel the alert state when they enter or exit the security zone.

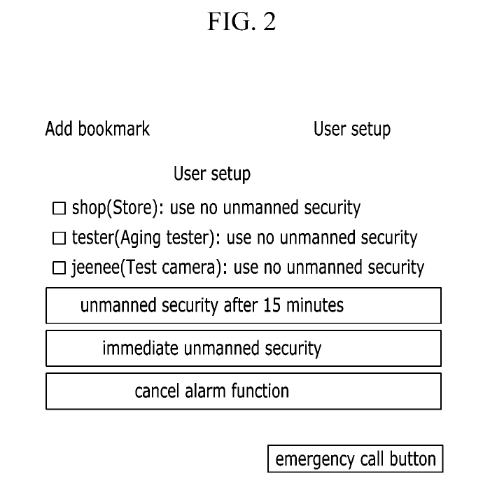

Specifically, when an analog switch displayed as an icon on the terminal 180 is pressed, an unmanned security page is displayed, as shown in FIG. 2, and an unmanned security alert state is easily set by selecting a predetermined item.

According to an exemplary embodiment of the present invention, the same effect can be obtained only with software without mechanical modification or installation and the alert state can be set and changed more flexibly.

A detailed description will be given of a method for controlling an unmanned security service using the unmanned security system using a network according to an exemplary embodiment of the present invention.

<Description of Method>

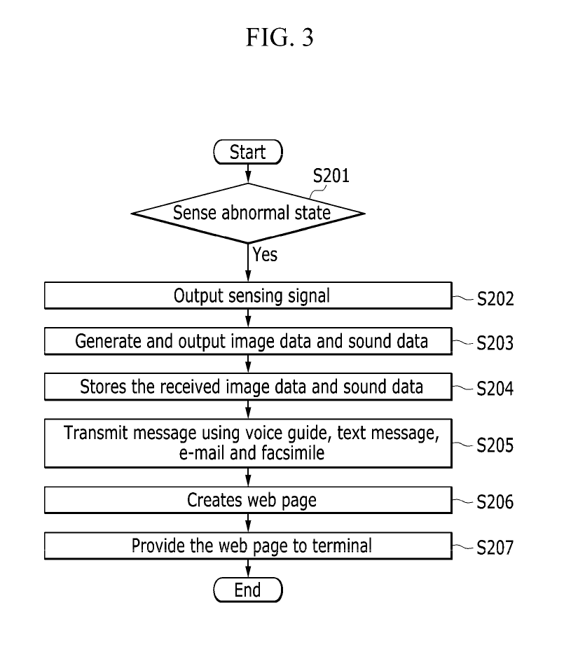

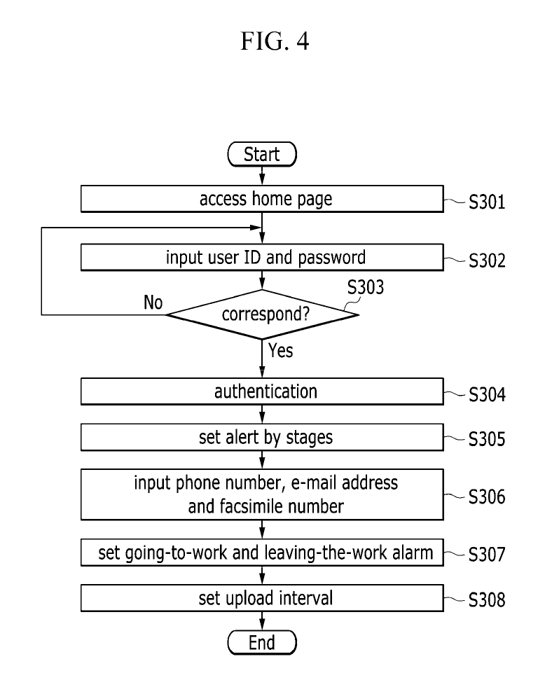

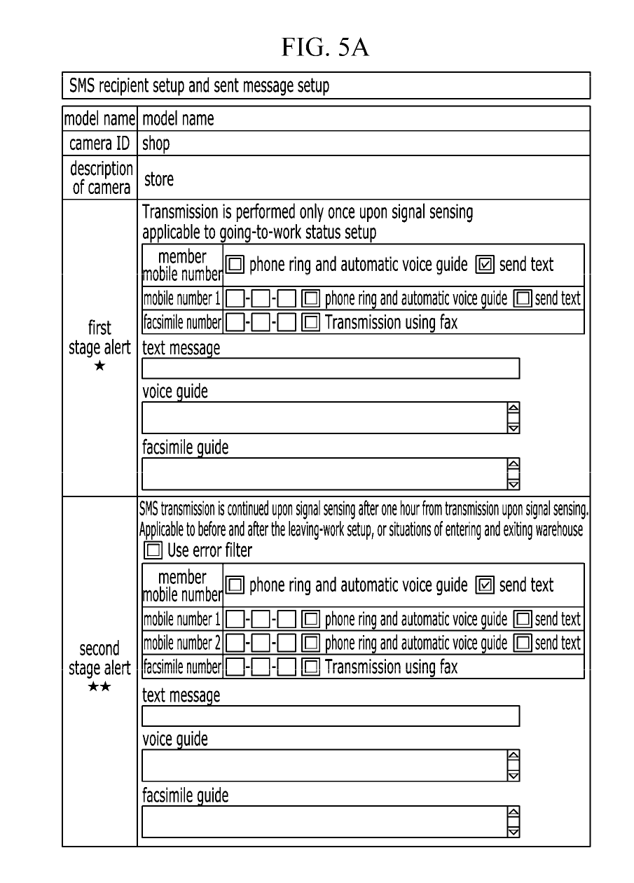

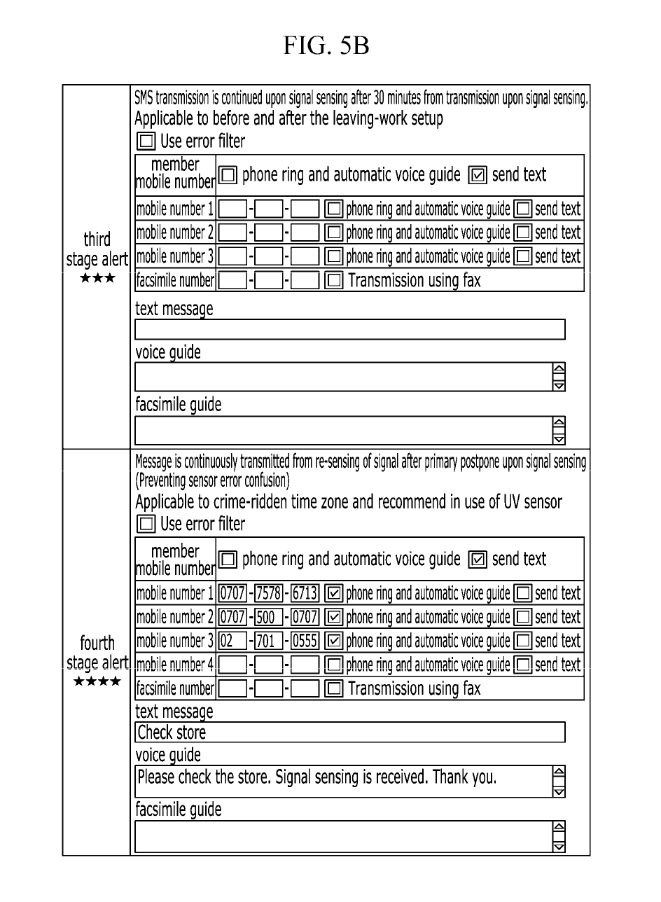

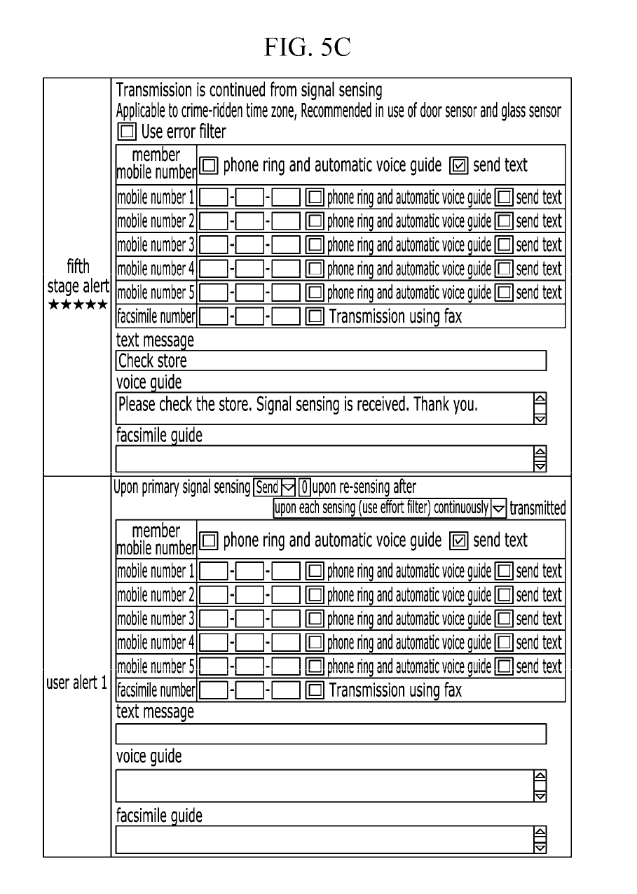

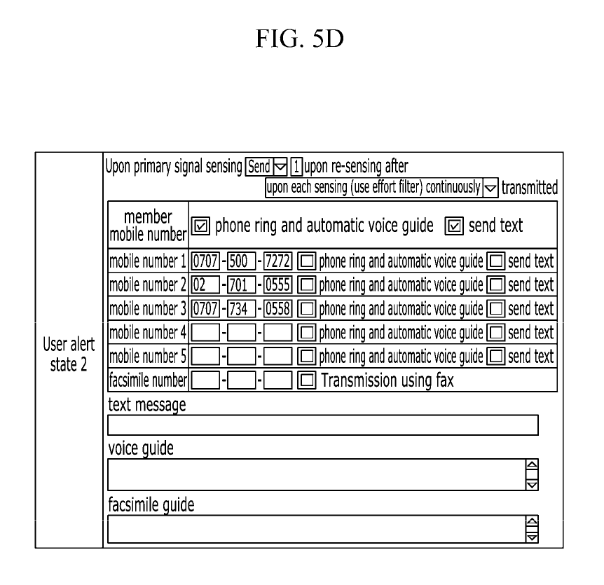

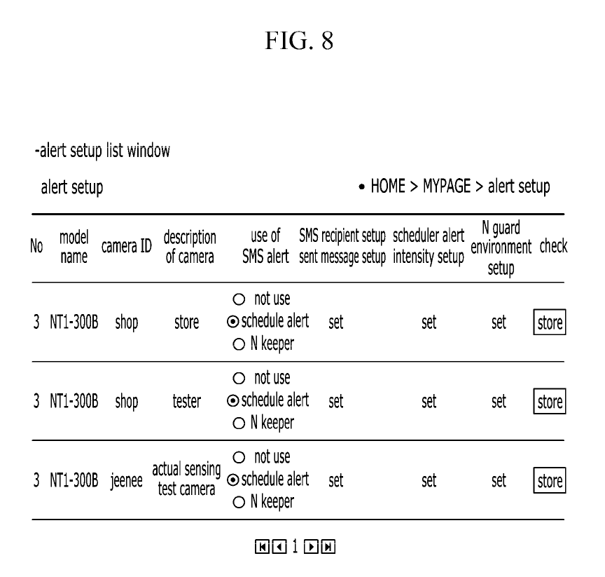

FIG. 3 is a flowchart illustrating a method for providing an unmanned security service using a network according to an exemplary embodiment of the present invention and FIG. 4 is a flowchart illustrating a method for setting an unmanned security system using a network according to an exemplary embodiment of the present invention. FIGS. 5, 6 and 7 show exemplary display screens for explaining the method for setting an unmanned security system using a network according to an exemplary embodiment of the present invention, and FIG. 8 shows an alert setting list window in the unmanned security system using a network according to an exemplary embodiment of the present invention.

Referring to FIG. 3, the method for providing an unmanned security service using a network according to an exemplary embodiment of the present invention is performed through the following steps.

When a plurality of sensors 110 senses an abnormal state of a specific location (S201) and outputs a sensing signal (S202), one or more cameras 120 generate and output image data and sound data (S203).

The management control server 130 manages states of the sensors 110 and the cameras 120, receives the image data and sound data from the cameras 120 and stores the received image data and sound data (S204).

The SMS transmission DB server 140 transmits a message regarding the abnormal state of the specific location to a plurality of users related to the specific location using at least two of voice guide, text message, e-mail and facsimile (S205).

The web server 150 creates a web page with security related information (S206) and provides the web page to the terminal 180 over the network 10 (S207).

The image data and sound data are provided in a peer-to-peer manner, and thus a user can check the image data and sound data through the built-in web server 151.

The unmanned security service is provided to users through the above-described procedure. This procedure is similar to the operation of the unmanned security system, explained in <description of system> so that explanation thereof is omitted.

In the meantime, the user is required to set the unmanned security system 100 on the web page in advance for step S205. This is described with reference to FIGS. 4, 5, 6 and 7.

As shown in FIG. 4, the user accesses the home page which administrates the unmanned security system 100 using a network (S301) and inputs a user ID and password if authentication is needed (S302).

It is determined whether the input user ID and password correspond to set user ID and password (S303), and an alert state of a specific location is set according to at least two of a predetermined time period, camera location, alert importance degree, night and day, and situation through the web page (S305) when authentication has been successfully performed according to the determination (S304).

The plurality of users input at least one of phone numbers, e-mail addresses and facsimile numbers such that the message regarding the abnormal state of the specific location is transmitted to the users using at least two of voice guide, text message, e-mail and facsimile according to the step of setting the alert state of the specific location (S306).

As a consequence, the users can set various scenarios that meet situations and environment that the users desire.

That is, states can be established by steps, as shown in FIG. 5. Accordingly, over 500 states can be set and when an abnormal state is generated, a message regarding the abnormal state can be transmitted using a contact number of a user, which is selected based on the current state.

If the time when the sensing signal corresponding to the abnormal status of the specific location is output corresponds to the going-to-work hour and the leaving-work hour, going-to-work and leaving-the-work alarm is set such that going-to-work and leaving-the-work message is transmitted to the user (S307). An interval of uploading the image data generated by the camera 120 to the file server 170 can be set in order to separately store the image data (S308).

Accordingly, the user can check going-to-work and leaving-work through the alarm and set the image data upload interval as necessary.

In addition, the present invention can set contents of the transmitted message using the voice guide, text message, e-mail and facsimile.

For example, the user can set going-to-work and leaving-work greetings in the event of going-to-work and leaving-work alarm, and determine contents of a message which indicates a trespassing in the event of the trespassing. In this case, when the user inputs a desired message, the message is automatically converted into a voice such that the message can be delivered as a distinct voice. Further, the message can be provided in English.

In step S305, it can be configured that the message is continuously transmitted from the time when the abnormal status of the specific location is sensed, or transmitted when the abnormal status is re-sensed after the lapse of a predetermined time from the time when the abnormal status of the specific location is sensed. In this manner, the message is transmitted when condition values depending on a selected time and method are satisfied even when an abnormal status is generated.

The present invention may select one of a previous schedule alert state and immediate alert state. Here, error filtering is additionally set.

Since many people may simultaneously receive a signal in the middle of the night, whether the signal is valid or not is important. Accordingly, error filtering is preferably introduced to eliminate inconvenience due to an erroneous signal.

Erroneous cases include a case in which a dog or a cat passes in the security zone, a case in which the infrared sensor is shined, a case in which radio wave interference occurs, a case in which an error of the unmanned security system is generated, a wrong system installation case, a fire case, a modification case, etc.

While error filtering using a sensor is used in general, the above-mentioned error filtering is needed because many signals are integrated to be used.

The error filtering is configured in such a manner that a first signal is ignored unconditionally on the assumption that a plurality of signals is sensed over twice or three times in case of genuine signals.

For example, the first signal disappears if another signal is not sensed within 30 minutes which is adjustable by the user and when a signal is sensed after the lapse of 30 minutes, this signal is received as a first signal.

Error signals can be remarkably reduced by the error filtering, and signal reliability can be maximized since only valid signals are sensed.

Specifically, it is possible to configure such that a message is transmitted only once when an abnormal status is sensed, as in a first-stage alert state shown in FIG. 5. This may be applied when a going-to-work status which does not require continuous message transmission is set.

In a second-stage or third-stage alert state, it is configured such that an SMS message is continuously transmitted after the lapse of 30 minutes or one hour from when a message regarding an abnormal status is sent using error filtering. This may be applied to situations before and after the leaving-work state, or situations of entering and exiting a warehouse, for example.

A fourth-stage alert state sets that transmission of a message with respect to a sensed abnormal state is postponed and then the message is continuously transmitted from when the abnormal state is re-sensed. A fifth-stage alert state notifies emergency at a highest level and continuously transmits a message when an abnormal state is sensed.

It is possible to configure such that a message is transmitted when a first signal is sensed and the message is continuously sent whenever a signal is sensed as in user alert 1 or user alert 2. Further, it is also possible to configure such that a message is transmitted when a first signal is sensed, and then the message is continuously sent when a signal is sensed again after the lapse of time that the user desires (for example, ten minutes).

Accordingly, it is possible to set more detailed alert states and prevent confusion due to an erroneous operation of the sensor 110.

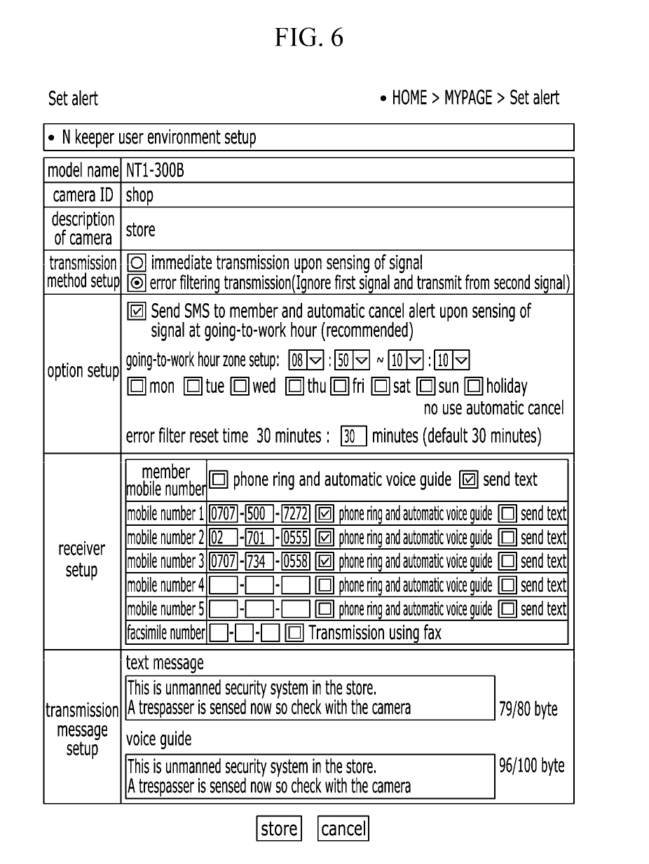

In the meantime, an unmanned security setting window called N guard setting window, as shown in FIG. 6, can be displayed on the terminal 180. The user can rapidly access the unmanned security setting window through WYSIWYG, shortcut button or the like to request unmanned security to be set.

In this case, the user can rapidly access the unmanned security setting window through the shortcut button on the terminal 180 without accessing the corresponding web page.

The N guard setting window can be operated in such a manner that security is initiated by pressing a start button and security is ended automatically. The N guard setting window can allow the user to set such that security is initiated in the event of going-to-work and leaving-work using a predetermined icon on the terminal 180.

For example, it is possible to set the immediate alert or alert after 15 minutes, cancel the immediate alert, change scheduler alert to automatic alert, and cancel the automatic alert when going to work using a simple interface as shown in FIG. 6,

Here, the alert after 15 minutes set a state in which an alert state is started after the lapse of 15 minutes for which the user can leave the work. If the user uses a computer, an alert state is started after the lapse of 15 minutes from when the user leaves the computer.

According to the immediate alert, alert is executed by means of a mobile terminal or a remote PC, and when someone visits the corresponding place, the alert state is released and then re-set.

Immediate cancellation can cancel any alert state unconditionally.

Even if a scheduler user wants to visited the security zone unexpectedly, the immediate cancellation can be set by means of a mobile terminal or a PC.

Automatic alert change in the scheduler alert allows the scheduler alert to be changed to N guard alert when a predetermined icon, for example, N guard button, is clicked (manual alert is set) even when the scheduler alert is being used and enables immediate execution of cancellation (of manual alert) and initiation of alert.

An automatic alert cancellation function during going-to-work period can be used in the case of fixed going-to-work hour. When people enter the security zone at a set time, the alert state is automatically cancelled and the entrance is not considered as a trespass. According to the automatic alert cancellation function, it is possible to eliminate inconvenience of canceling the alert state whenever required and automatically check going-to-work hours of employees.

As described above, unmanned security setup can be simplified using a simple security setting window such as the N guard setting window without a complicated procedure which processes a large amount of data through the Internet and includes multiple steps, such as scheduler alert, so as to allow the user to be easily use the unmanned security system. In addition, the unmanned security system can be used through a mobile terminal without a communication trouble such as data overflow.

Here, since the number of users depends on alert stages and the first stage and fifth stage are used in most cases, there is no need to input information about all the users. Further, when a member contact number has been checked, a phone call is made or an SMS message is sent using a mobile phone number which corresponds to the checked contact number and is registered in the event of member subscription.

“Contact number” corresponds to a general phone number or a cellular phone number and in the case of Internet phone or cellular phone, an SMS message and phone call may be simultaneously received. A phone number of a neighboring place which can be in contact with in case of emergency, such as a neighboring house, neighboring store, or neighboring office, is preferably registered as the phone number. The night is divided into a night time and a midnight time for more flexible setting.

For example, it is possible to set a security office or a disaster prevention office in the case of an apartment, and set a night-duty room, security office, a home of a co-worker who lives near an office in the case of the office to thereby accomplish perfect security service.

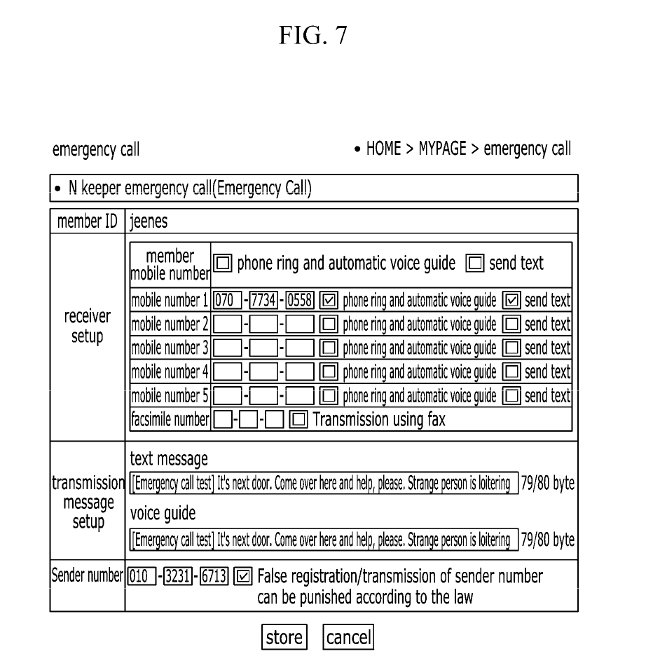

Furthermore, an emergency call setting window may be constructed as shown in FIG. 7. The user can transmit an emergency call to a maximum of seven places in real time through the emergency call window by pressing an emergency call button. In this case, phone numbers of neighbor houses, neighbor stores, or neighbor offices are input in advance and used in case of emergency such that concerned people can help each other in accident situations other than crimes.

In addition, an additional alert setting list window is provided as shown in FIG. 8. Simple alert setup, schedule alert setup, and whether or not alert setup is used are independently set using an icon such as an N guard icon through the alert setting list window when three cameras are present for one ID, to thereby set various alert states while reducing the number of hardware components and check the current alert set state through the alert setting list window.

Those skilled in the art will appreciate that the present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be within the scope of the invention.

<Description of symbols>

100: unmanned security system using network

| | |
|---|---|
| 110: sensor | |
| 120: camera | |
| 130: management control server | 140: SMS transmission DB server |
| 150: web server | 160: alarm server |
| 170: file server | 180: terminal |
| 190: DDNS server | 151: built-in web server |
| 200: SMS integrated server | |

What is claimed is:

1. An unmanned security system using a network, comprising:
a plurality of sensors configured to sense an abnormal state of a specific location and output a sensing signal;
one or more cameras installed in the specific location and configured to generate image data and sound data and output the image data and sound data;
a Dynamic Domain Name Service (DDNS) server configured to manage Internet addresses for Internet access to provide the image data and sound data of the cameras;
an SMS transmission DB server configured to transmit a message regarding the abnormal state of the specific location to a plurality of users related to the specific location using at least two of voice guide, text message, e-mail and facsimile when the abnormal state of the specific location is sensed through the sensors and/or the cameras;
a web server configured to create a web page with security related information;
a management control server configured to manage states of the sensors and the cameras, receive the image data and sound data from the cameras, store the received image data and sound data, and administrate the DDNS server, the SMS transmission DB server and the web server in an integrated manner; and
a terminal configured to receive the web page through the network.

2. The unmanned security system of claim 1, further comprising an alarm server configured to inform a user of an abnormal operation state of the camera when the cameras is not operated normally.

3. The unmanned security system of claim 1, further comprising a file server configured to separately store the image data.

4. The unmanned security system of claim 1, wherein the camera is rotated by 360 degrees horizontally and by 80 degrees vertically.

5. The unmanned security system of claim 1, wherein the camera have a robbery tracking function such that the management control server notifies the user that the camera is used by a person other than the user through SMS when the camera is stolen and used by the person.

6. The unmanned security system of claim 1, wherein the SMS transmission DB server selectively transmits a message on the basis of alert importance predetermined by the user.

7. The unmanned security system of claim 6, wherein the web server supports at least one of an unmanned alert schedule setting window, an unmanned alert setting window, an alert initiation and emergency call button window, and an emergency call setting window, and a user who has notified of the abnormal state of the specific location by the SMS transmission DB server changes contact numbers of the plurality of users according to situation.

8. The unmanned security system of claim 1, further comprising a built-in server configured to provide the image data and sound data in a peer-to-peer manner.

9. A method for providing an unmanned security service through a network, the method comprising:
generating image data and sound data from one or more cameras when a plurality of sensors sense an abnormal state of a specific location and outputting a sensing signal;
managing states of the sensors and the camera, receiving the image data and sound data from the camera and storing the received image data and sound data;
transmitting a message regarding the abnormal state of the specific location to a plurality of users related to the specific location using at least two of voice guide, text message, e-mail and facsimile;
supporting at least one of an unmanned alert schedule setting window, an unmanned alert setting window, an alert initiation and emergency call button window, and an emergency call setting window, and creating a web page with security related information; and
providing the web page to a terminal through the network.

10. The method of claim 9, wherein the user of the camera is notified of an abnormal operation state of the camera when the camera is not normally operated.

11. The method of claim 9, wherein the image data is separately stored in a file server.

12. The method of claim 9, wherein the camera is rotated by 360 degrees horizontally and by 80 degrees vertically.

13. The method of claim 9, wherein the camera has a robbery tracking function such that the user of the camera is notified that the camera is stolen and used by a person other than the user through SMS when the camera is stolen and used by the person.

14. The method of claim 9, wherein the transmitting of the message selectively transmits the message on the basis of alert importance predetermined by the user.

15. The method of claim 9, wherein the image data and sound data are provided in a peer-to-peer manner.

16. A method for setting an unmanned security system using a network, the method comprising:
accessing a home page which administrates the unmanned security system using a network;
inputting a user ID and password when authentication is needed;
determining whether the input user ID and password correspond to a predetermined user ID and password;
upon authentication according to the determination, setting an alert state of a specific location through a web page based on at least two of a predetermined time period, camera location, alert importance, nighttime and daytime, and situation; and
receiving at least one of a phone number, e-main address and facsimile number of each of a plurality of users such that a message regarding an abnormal state of the specific location is transmitted to the plurality of users using at least two of voice guide, text message, e-mail and facsimile according to the setting of the alert state of the specific location.

17. The method of claim 16, further comprising setting going-to-work and leaving-work alarm such that going-to-work and leaving-work messages are transmitted to the plurality of users when the time when a signal corresponding to the sensed abnormal state of the specific location is output corresponds to the going-to-work hour and leaving-work hour.

18. The method of claim 16, further comprising setting an interval of uploading the image data generated by the camera to a file server such that the image data is separately stored.

19. The method of claim 16, wherein contents of the message transmitted using voice guide, text message, e-mail and facsimile is predefined.

20. The method of claim 17, wherein the setting of the alert state sets such that the message is continuously transmitted from when the abnormal state of the specific location is sensed or the message is transmitted when the abnormal state is re-sensed after the lapse of a predetermined time from the time when the abnormal state of the specific location is sensed.

21. The method of claim 20, wherein the setting of the alert state uses at least one of an unmanned alert schedule setting window, an unmanned alert setting window, an alert initiation and emergency call button window, and an emergency call setting window.

22. The method of claim 21, wherein the unmanned alert setting window includes error filtering transmission for setting such that the message is transmitted when the abnormal state is re-sensed, and at least one of immediate alert, alert after 15 minutes, immediate cancellation, automatic alert change in scheduler alert, and automatic alert cancellation in case of going-to-work.
